(19) United States
(12) Patent Application Publication
(10) Pub. No.: US 2008/0030478 A1
(43) Pub. Date: Feb. 7, 2008

(54) DIGITAL PHOTO FRAME

(75) Inventors: Xiao-Guang Li, Shenzhen City (CN); Kuan-Hong Hsieh, Shenzhen City (CN); Hua-Dong Cheng, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Pan Chiao City (TW)

(21) Appl. No.: 11/833,256

(22) Filed: Aug. 3, 2007

(30) Foreign Application Priority Data
Aug. 4, 2006 (CN) 200610061978.4

(51) Int. Cl. G09G 5/00

(52) U.S. Cl. 345/173

(57) ABSTRACT

A digital photo frame includes a processing unit (110), a display controller (120), a display unit (130) and a control panel (150). The processing unit modifies an original image from an original image file (210) stored in a first storage (20) according to modifying instructions received from the control panel, saves modifying parameters relating to the modification in an image modification file (220) that is stored in a second storage (30) and corresponds to the original image file. After the modification, if the original image is selected at a later time, the processing unit automatically modifies the original image according to the modifying parameters, thereby producing a modified image to be displayed on the display unit.

### CROSS REFERENCE TO RELATED APPLICATION

This application is related to a pending application entitled “APPARATUS AND METHOD FOR PROCESSING, STORING AND DISPLAYING DIGITAL IMAGES”, filed around the same time that this application is filed. The entire contents of the related application are incorporated herein by reference.

### BACKGROUND OF THE INVENTION

1. Technical Field

The present invention relates to a digital photo frame.

2. General Background

Digital photo frames display digital images without the need to print the digital images out and are in people's favors.

Digital photo frames has generally been provided with many tools to manipulate and edit a displayed image. The displayed image can be edited, for example, can be resized, rotated, trimmed, text added, and the like. The edited image can be saved by replacing the original image or be saved separately from the original image.

Distortion is generally produced after editing of digital images. For example, after being trimmed, the edited image quality is reduced as compared with the original image. If the edited image is saved separately from the original image, storage space of the digital photo frames increases.

Therefore, there is a need for a digital photo frame which can solve at least the problems listed above.

### SUMMARY

A digital photo frame is provided. The digital photo frame includes a display unit; a control panel for receiving operation inputs and outputting operation instructions accordingly, the operation instruction comprising image select instructions, modifying instructions and save image instructions; and a processing unit connected to a first storage and a second storage. The first storage saves a plurality of original image files which records original image data of a plurality of original images, and the second storage saves one or more image modification files that correspond to one or more of the original image files and each records at least one modifying parameter. The processing unit reads original image data of an original image from an original image file according to an image select instruction from the control panel, and outputs an image on the display unit, the image is the original image if a corresponding image modification file does not exist in the second storage, or the image is a first modified image which is derived from the original image by applying modifying parameters of the corresponding image modification file to the original image data if the corresponding image modification file exists in the second storage. The processing unit modifies data of the image to produce a second modified image according to the modifying instructions from the control panel, and save new modifying parameters relating to the modification in the corresponding image modification file according to a save image instruction from the control panel.

Other advantages and novel features will be drawn from the following detailed description with reference to the attached drawings.

### BRIEF DESCRIPTION OF THE DRAWINGS

FIG. 1 is a schematic diagram of a digital photo frame in accordance with a first embodiment of the present invention;

FIG. 2 is a schematic diagram of a processing unit of the digital photo frame of FIG. 1;

FIG. 3 shows contents of a storage of the digital photo frame of FIG. 1;

FIG. 4 is a schematic diagram of a digital photo frame in accordance with a second embodiment of the present invention; and

FIG. 5 is a flowchart of a method for digital photo frames of FIGS. 1, 4 and 5 to processing, storing and displaying digital images.

### DETAILED DESCRIPTION OF THE EMBODIMENTS

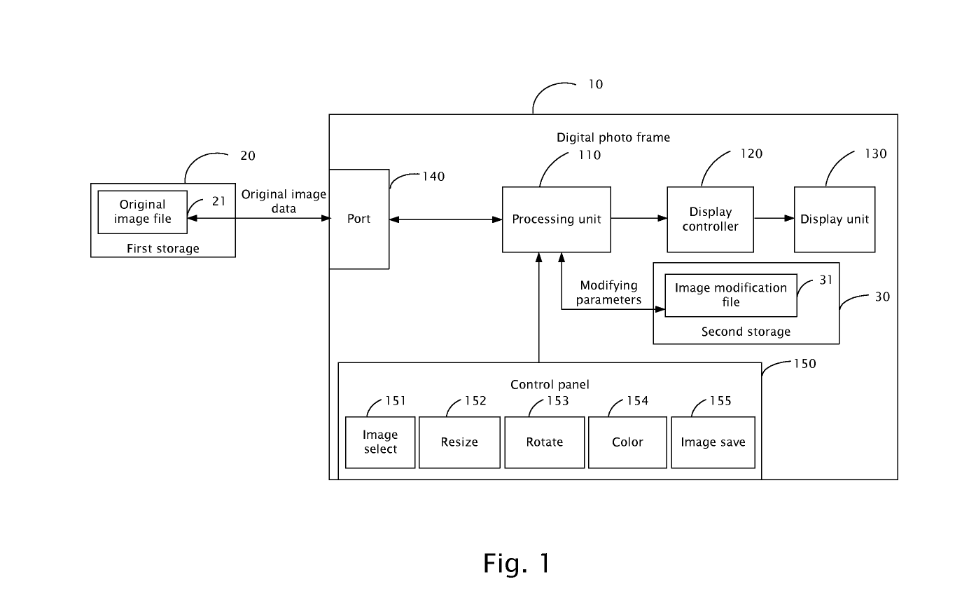

Referring to FIG. 1, a digital photo frame in accordance with a first embodiment of the present invention is shown. The digital photo frame 10 includes a processing unit 110. The processing unit 110 is connected with a port 140 that is configured on the first photo frame 10. The port 140 is configured for connecting with a first storage 20. In the preferred embodiment, the first storage 20 is an external storage device of the digital photo frame 10. The port 140 is of any suitable known type and the first storage 20 is of any suitable known type that can be coupled with the port 140. Typically, the first storage 20 is a secure digital card (SD card) that has been widely used as a portable storage device for electronic devices. The first storage 20 is provided for saving a plurality of original image files 21 (only one shown) and provides original image data of original images to the processing unit 110. The processing unit 110 is also connected with a second storage 30. In the preferred embodiment, the second storage 30 is an internal storage device of the digital photo frame 10 and the processing unit 110 accesses the second storage 30 via an internal bus (not labeled). The second storage 30 is configured for saving one or more image modification files 31 (only one shown) corresponding to one or more of the original image files 21. The image modification files 31 receive modifying parameters from the digital photo frame 10 after modifications are applied to the original image data according to operation inputs received by the digital photo frame 1. The image modification files 31 also provide the modifying parameters to the digital photo frame 10 to yield a modified image. The modified image is then displayed on a display unit 130 of the first digital frame 10 via a display controller 120.

The processing unit 110 is connected with a control panel 150 that includes a plurality of input units. The input units are configured for receiving the operation inputs and outputting operation instructions to the processing unit 110 correspondingly. The input units may include but not be limited to an image select button 151, a resize button 152, a rotate button 153, a color button 154, and an image save button 155. It must be stated that the “buttons” used here refer to all types of input devices that can be operated on to receive operational inputs and accordingly produce operation instructions. The “buttons” may be mechanical input devices, electronical input devices (e.g., touch panels) or software icons displayed on a user interface. Accordingly, the operation instructions include but are not limited to image select instructions, modifying instructions (including zoom-in instructions, zoom-out instructions, rotate instructions, and color modification instructions), and save image instructions. These operation instructions can be produced through the image select button 151, the resize button 152, the rotate button 153, the color button 154, and the image save button 155 correspondingly.

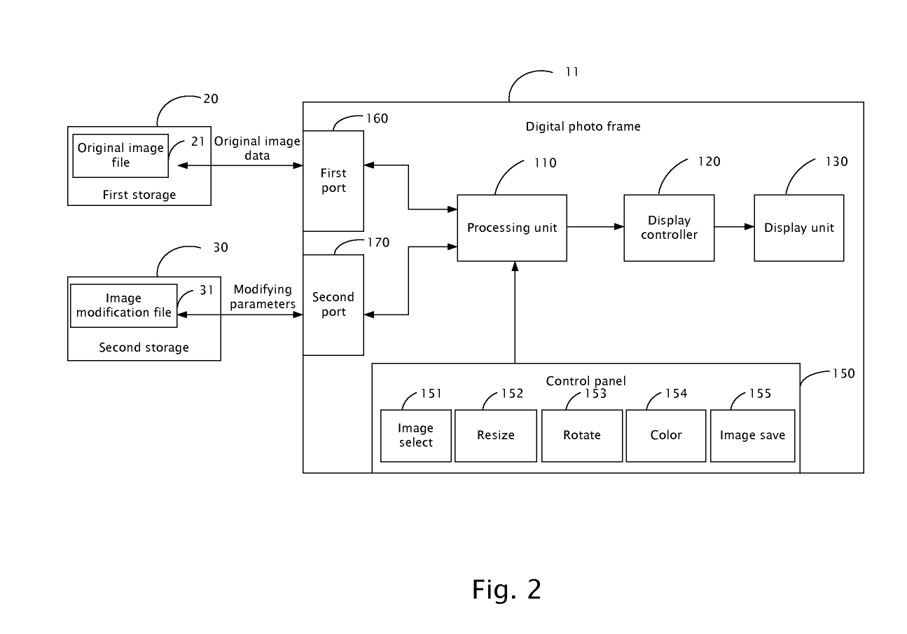

Referring to FIG. 2, a digital photo frame in accordance with a second embodiment of the present invention is shown. The digital photo frame 11 is configured with two ports which are hereinafter referred to as a first port 160 and a second port 170. The first storage 20 and the second storage 30 are both external storages of the digital photo frame 11. The first storage 20 is connected to the digital photo frame 11 via the first port 160 and the second storage 30 is connected to the digital photo frame 11 via the second port 170.

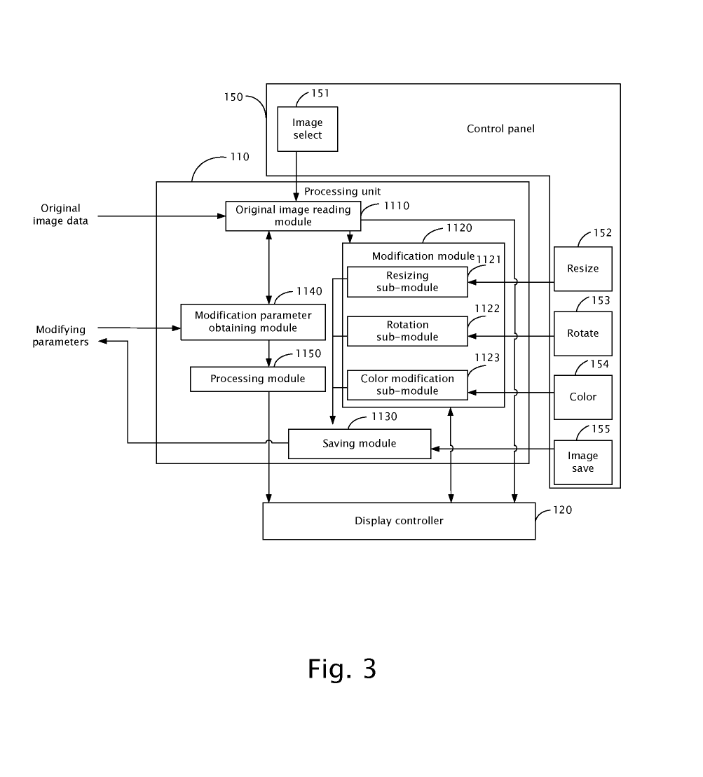

Referring to FIG. 3, the processing unit 110 includes an original image reading module 1110 and a modification module 1120. The original image reading module 1110 is configured for receiving the an image select instruction from the image select button 151 of the control panel 150, searching the first storage 20 for an original image file 21, and reading original image data from the original image file 21. The original image reading module 1110 is also configured for outputting an original image of the original image file 21 on the display unit 130 via the display controller 120.

When the modifying instructions are received from the control panel 150, the original image reading module 1110 transmits the original image data to the modification module 1120 as a temporary image file. The modification module 1120 is configured for modifying data of the temporary image file according to the modification instructions, thereby yielding modified image data. The modification module 1120 is further configured for displaying a modified image of the modified image data on the display via the display controller 120. The control panel 150 includes the resize button 152, the rotate button 153, and the color button 154 that are configured for producing and transmitting the modifying instructions. The resize button 152, the rotate button 153, and the color button 154 are provided for illustration purpose only, and the control panel 150 may include other buttons used to produce and transmit the modifying instructions. The modification module 1120 includes a resizing sub-module 1121, a rotation sub-module 1122, and a color modification sub-module 1123. The resizing sub-module 1121, the rotation sub-module 1122 and the color modification sub-module 1123 are also provided for illustration purpose only, and the modification module 1120 may include other sub-modules used to modify data of the temporary image file according to the modifying instructions.

In particular, the resizing sub-module 1121 is configured for modifying data of the temporary image file, such that an image size of the modified image is different than a size of the original image according to the zoom-in instructions and/or the zoom-out instruction from the resize button 152.

The rotation sub-module 1122 is configured for modifying data of the temporary image file such that an orientation of the modified image can be rotated 90 degrees clockwise or 90 degrees counterclockwise relative to the original image according to the rotate instructions from the rotate button 153.

The color modification sub-module 1123 is configured for modifying data of the temporary image file, such that a color of the modified image is different than a color of the original image according to the color modification instructions from the color button 154.

The processing unit 110 further includes a saving module 1130. The saving module 1130 is configured for receiving a save image instruction and for generating an image modification file 31 according to the temporary image file and the original image file 21. The image modification file 31 consists of at least one modifying parameter. In a first preferred embodiment, the at least one modifying parameter is a total modification result of the modified image relative to the original image of a same modifying instruction type. In a second embodiment, the at least one modifying parameter is a modification instruction transmitted by the control panel 150 and applied to the temporary image file.

As an overview, after the modifying parameters corresponding to an original image are stored, each time the original image is selected according to the image select instructions transmitted from the image selector button 510, a modified image derived from applying the modifying parameters on the original image is outputted and displayed on the display unit 130. This process is described more detail below.

The processing unit 110 further includes a modifying parameter obtaining module 1140 and a processing module 1150. The original image reading module 1110 reads the original image data from the original image file 21 according to the image select instruction transmitted by the image selector button 510. The modifying parameter obtaining module 1140 obtains the modifying parameters from the image modification file 31 corresponding to the original image file 21. The processing module 1150 processes the original image data according to the modifying parameters to produce the modified image and outputs the modified image to the display unit 130.

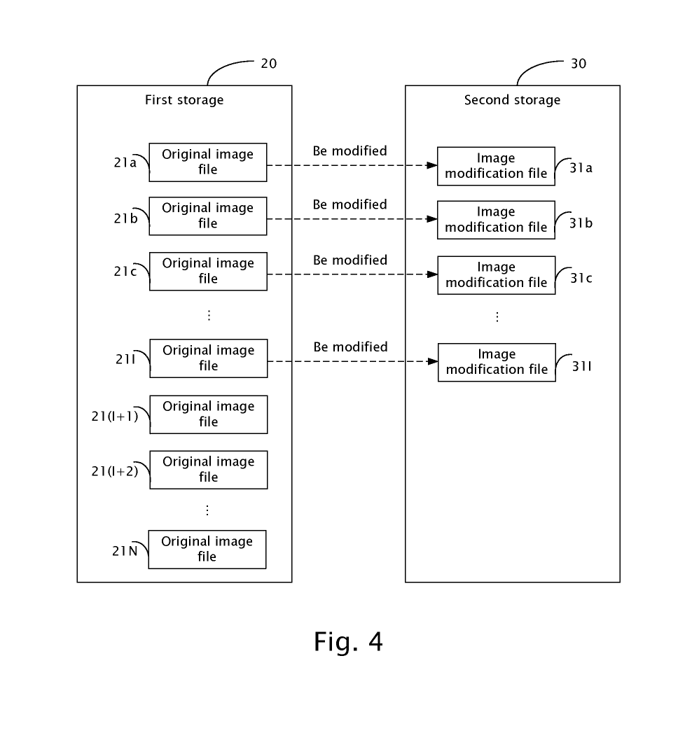

Referring to FIG. 4, in an exemplary embodiment, the first storage 20 stores a plurality of original image files symbolically labeled from 210 to 21n, among which, the original image files through 210 to 21i have been processed and corresponding image modification files through 310 to 31i has been saved in the second storage 30, and the original image files through 21(i+1) to 21n remain unprocessed. Wherein, i and n are any natural number except 0, and n is greater than i. Therefore, when the image select instructions are received by the processing unit 110, the processing unit 110 reads the original image data from the original image files 21 according to the image select instructions. The processing unit 110 outputs the original images of the original image file 21 to the display unit 130 if the original image files 21 list among the original image files 21(i+1)−21n. Or the processing unit 110 outputs the modified images to the display unit 130 if the original image files 21 list among the original image files 211-21i. The modified images are modified from the original images according to the modifying parameters recorded by the image modification files 31 that correspond to the original image files 21.

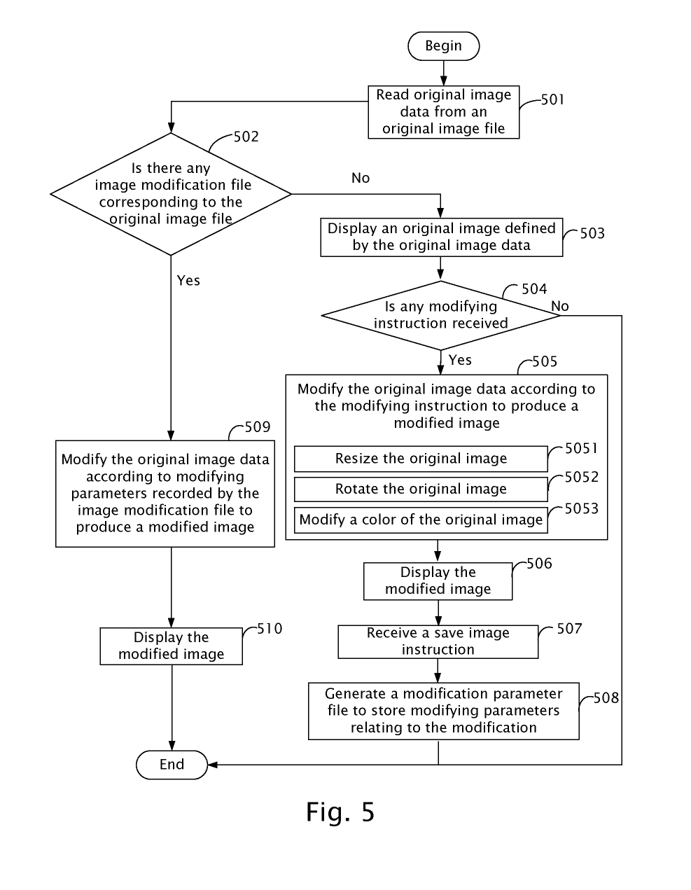

FIG. 5 is a flowchart of processing, storing and displaying digital images. The flowchart starts with step S501, the original image reading module 1110 receives an image select instruction from the image select button 151 and reads original image data from an original image file 21 according to the image select instruction, the original image reading module 1110 signals the modifying parameter obtaining module 1140 to obtain modifying parameters. In step S502 the modifying parameter obtaining module 1140 determines whether an image modification file 31 that corresponds to the original image file 21 exists.

If the image modification file 31 does not exist, in step S503, the original image reading module 1110 transmits the original image data to the display controller 120, thereby displaying an original image of the original image file 21 on the display unit 130. In step S504 the modification module 1120 determines whether any modifying instruction is received and the procedure finishes if no modifying instruction is received. If any modifying instruction is received, the procedure advances to Step S505, the original image reading module 1110 transmits the original image data as a temporary image file to the modification module 1120, and the modification module 1120 modifies data of the temporary image file according to the modifying instruction, thereby producing modified image data.

Step S505 may include one or more sub-steps depending on that the number of modification instructions is received. For example, Sub-steps 5051, S5052 and S5053 are included in Step S505 if a zoom-in instruction (or a zoom-out instruction), a rotate instruction and a color modification instruction are received. In Sub-step S5051 the resizing sub-module 1121 modifies data of the temporary image file, such that an image size of a modified image of the modified data is different from a size of the original image according to the received zoom-in instruction (or zoom-out instruction). In Sub-step S5052 the rotation sub-module 1122 modifies data of the temporary image file, such that the modified image is rotated by 90 degrees clockwise or counterclockwise relative to the original image according to the rotate instruction. In Sub-step S5053 the color modification sub-module 1123 modifies data of the temporary image file, such that a color of the modified image is different from a color of the original image according to the color modification instruction. The modified image is accordingly produced by the modification module 1120 in step S505 and displayed on the display unit 130 in Step S506 by the display controller 120. The saving module 1130 receives a save image instruction from the image save button 155 in Step S507, and generates an image modification file 31 to record modifying parameters resulted by Step S505 in Step S508. The procedure then finishes.

If the image modification file 31 already exists according to step S502, the procedure advances to step S509, the modifying parameter obtaining module 1140 obtains modifying parameters recorded by the image modification file 31 and the processing module 1150 modifies the original image data according to the modifying parameters, so as to produce a modified image. The modified image is displayed on the display unit 130 in step S510 and the procedure accordingly finishes.

It must be stated that when the modified image is displayed on the display unit 130 and any modifying instruction is received from the control panel 150, a procedure similar to Steps S504-S508 described in FIG. 5 is implemented. The procedure is: a) the modification module 1120 modifies data of the modified image to produce a second modified image displayed on the display unit 130; and b) the saving module 1130 receives an save image instruction from the control panel 150, and updates the corresponding image modification file 31 with new modifying parameters resulted by a).

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A digital photo frame, comprising:
a display unit;
a control panel for receiving operation inputs and outputting operation instructions accordingly, the operation instructions comprising image select instructions, modifying instructions and save image instructions;
a processing unit connected with a first storage and a second storage, the first storage saving a plurality of original image files which records original image data of a plurality of original images, and the second storage saving one or more image modification files that correspond to one or more of the original image files and each image modification file records at least one modifying parameter;
wherein:
the processing unit reads original image data of an original image from an original image file according to an image select instruction from the control panel, and outputs an image on the display unit, the image is the original image if a corresponding image modification file does not exist in the second storage, or the image is a first modified image which is derived from the original image by applying modifying parameters of the corresponding image modification file to the original image data if the corresponding image modification file exists in the second storage;
the processing unit modifies data of the image to produce a second modified image according to the modifying instructions from the control panel, and save new modifying parameters relating to the modification in the corresponding image modification file according to a save image instruction from the control panel.

2. The digital photo frame according to claim 1, wherein the new modifying parameters comprises at least one total modification result of the second modified image relative to the original image of.

3. The digital photo frame according to claim 1, wherein the new modifying parameters comprises the modifying instructions.

4. The digital photo frame according to claim 1, wherein the processing unit generates the corresponding image modification file in the second storage if the corresponding image modification file does not exist in the second storage.

5. The digital photo frame according to claim 1, wherein the processing unit updates the corresponding image modification file with the new modifying parameters if the corresponding image modification file already exists in the second storage.

6. The digital photo frame according to claim 1, further comprising a first port and a second port, wherein the first port is configured for connecting the first storage to the processing unit and the second port is configured for connecting the second storage to the processing unit.

7. The digital photo frame according to claim 1, further comprising a port configured for connecting the first storage to the processing unit.

8. The digital photo frame according to claim 7, wherein the processing unit is connected to the second storage via an internal bus.
